(19) United States
(12) Patent Application Publication
(10) Pub. No.: US 2026/0145654 A1
(43) Pub. Date: May 28, 2026

(54) BRAKE SYSTEM AND CONTROL METHOD THEREOF

(71) Applicant: HL MANDO CORPORATION, Pyeongtaek (KR)

(72) Inventor: Jaehoon JANG, Pyeongtaek (KR)

(21) Appl. No.: 19/171,365

(22) Filed: Apr. 7, 2025

(30) Foreign Application Priority Data
Nov. 25, 2024 (KR) 10-2024-0170122

(51) Int. Cl. B60T 8/1766

(52) U.S. Cl. CPC B60T 8/1766

(57) ABSTRACT

A brake system comprises: a plurality of wheel speed sensors respectively provided on wheels of a vehicle; a hydraulic brake provided on a first wheel of the vehicle; an electromechanical brake provided on a second wheel of the vehicle; a first controller configured to perform braking control for the hydraulic brake and the electromechanical brake based on a pedal displacement signal corresponding to a movement of a brake pedal or at least one among wheel speed signals output from the plurality of wheel speed sensors; and a second controller configured to, when a failure of the first controller is identified, perform braking control for the hydraulic brake and the electromechanical brake based on the pedal displacement signal or at least one of wheel speed signals output from the plurality of wheel speed sensors, wherein the electromechanical brake comprises a third controller configured to, when failures of the first controller and the second controller are identified, perform braking control for the electromechanical brake based on the pedal displacement signal or at least one among wheel speed signals output from the plurality of wheel speed sensors.

### CROSS-REFERENCE TO RELATED APPLICATION(S)

This application is based on and claims priority under 35 U.S.C. § 119 to Korean Patent Application No. 10-2024-0170122, filed on Nov. 25, 2024, in the Korean Intellectual Property Office, the disclosure of which is incorporated by reference herein in its entirety.

### BACKGROUND

### 1. Field

The disclosure relates to a brake system and a control method thereof.

### 2. Description of the Related Art

As automotive technology advances and the demands on driver and passenger safety increase, the need for more efficient and safer braking systems is increasing. Existing hydraulic brake systems have provided a certain level of braking performance by converting the operating force of the brake pedal into hydraulic pressure to generate a braking force, but have limitations in terms of response speed and accuracy and also have the disadvantage of low efficiency due to the complexity and weight of the hydraulic system.

To solve these problems, Integrated Dynamic Brake (IDB) system was developed to convert the operating force of the brake pedal into an electric signal and control the braking force electro-hydraulically. The IDB, which is an integrated electric brake that combines an electronic booster with Electronic Stability Control (ESC), enables faster and more accurate braking than conventional hydraulic systems, and provides improved stability and braking performance by making it easier to distribute and control a braking force. In addition, the IDB has great advantages in terms of efficiency as it simplifies and lightens the system by replacing the hydraulic system.

Meanwhile, an Electro-Mechanical Brake (EMB) is a brake that operates by a mechanical actuator rather than hydraulic pressure, and has the advantages of fast response and precise control. The EMB generates a braking force by driving a motor with an electric signal to operate a caliper. However, in the case of conventional internal combustion engine vehicles or hybrid vehicles, general-purpose electric brakes other than the Electronic Wedge Brake (EWB) type have limitations in the braking power that can be generated with a voltage of 12 V, which limits application to the front wheels.

### SUMMARY

It is an aspect of the disclosure to provide a brake system and a control method thereof, capable of implementing situational redundancy by receiving wheel speed signals through multiple channels from wheel speed sensors provided on respective wheels.

It is an aspect of the disclosure to provide a brake system and a control method thereof, capable of improving braking stability by being robust against damage and/or errors of vehicle components.

It is an aspect of the disclosure to provide a brake system and a control method thereof, capable of stably performing braking control for hydraulic brakes of front wheels and electromechanical brakes of rear wheels.

Additional aspects of the disclosure will be set forth in part in the description which follows and, in part, will be obvious from the description, or may be learned by practice of the disclosure.

In accordance with an aspect of the disclosure, a brake system may include: a plurality of wheel speed sensors respectively provided on wheels of a vehicle; a hydraulic brake provided on a first wheel of the vehicle; an electromechanical brake provided on a second wheel of the vehicle; a first controller configured to perform braking control for the hydraulic brake and the electromechanical brake based on a pedal displacement signal corresponding to a movement of a brake pedal or at least one among wheel speed signals output from the plurality of wheel speed sensors; and a second controller configured to, when a failure of the first controller is identified, perform braking control for the hydraulic brake and the electromechanical brake based on the pedal displacement signal or at least one among wheel speed signals output from the plurality of wheel speed sensors, wherein the electromechanical brake may include a third controller configured to, when failures of the first controller and the second controller are identified, perform braking control for the electromechanical brake based on the pedal displacement signal or at least one among wheel speed signals output from the plurality of wheel speed sensors.

The plurality of wheel speed sensors may be configured to respectively output the wheel speed signals through a first channel and a second channel and output the wheel speed signals to the first controller through the first channel.

The wheel speed sensor provided on the first wheel may be configured to output the wheel speed signal to the second controller through the second channel, and the wheel speed sensor provided on the second wheel may be configured to output the wheel speed signal to the third controller through the second channel.

The first controller may be configured to perform braking control for the hydraulic brake and the electromechanical brake by receiving the wheel speed signal from at least one of the second controller and the third controller based on identification of a failure of the first channel.

The second controller may be configured to perform braking control for the hydraulic brake and the electromechanical brake by receiving a wheel speed signal from the third controller based on identification of a failure of the second channel.

The first controller may be configured to, when a failure of the wheel speed sensor provided on the second wheel is identified, perform braking control for the hydraulic brake and the electromechanical brake based on a wheel speed signal output from the wheel speed sensor provided on the first wheel.

The brake system may further include a first communication network connecting the first controller and the second controller, and each of the first controller and the second controller may identify a state of another party through the first communication network.

The brake system may further include a second communication network connecting the first controller and the third controller, and each of the first controller and the third controller may identify a state of another party through the second communication network.

The brake system may further include a third communication network connecting the second controller and the third controller, and each of the second controller and the third controller may identify a state of another party through the third communication network.

The brake system may further include a second communication network connecting the first controller and the third controller, a third communication network connecting the second controller and the third controller, and a fourth communication network connecting the electromechanical brake provided on the second wheel, and the second communication network and the third communication network may be connected in parallel to the fourth communication network.

The first controller or the second controller may be selectively connected to the fourth communication network through the second communication network or the third communication network based on an identified state of another party.

The brake system may further include a hydraulic supply module configured to supply hydraulic pressure to the hydraulic brake, and at least one of the first controller and the second controller may be configured to control the hydraulic pressure supply module to supply hydraulic pressure to the hydraulic brake.

The brake system may further include a first hydraulic pressure supply module and a second hydraulic pressure supply module configured to supply hydraulic pressure to the hydraulic brake, and at least one of the first controller and the second controller may be configured to control the first hydraulic pressure supply module and the second hydraulic pressure supply module to supply hydraulic pressure to the hydraulic brake.

According to another aspect of the disclosure, a method of controlling a brake system, the brake system including a plurality of wheel speed sensors respectively provided on wheels of a vehicle, a hydraulic brake provided on a first wheel of the vehicle, and an electromechanical brake provided on a second wheel of the vehicle, may include at a first controller, performing braking control for the hydraulic brake and the electromechanical brake based on a pedal displacement signal corresponding to a movement of a brake pedal or at least one among wheel speed signals output from the plurality of wheel speed sensors, at a second controller, when a failure of the first controller is identified, performing braking control for the hydraulic brake and the electromechanical brake based on at least one of the pedal displacement signal or at least one of wheel speed signals output from the plurality of wheel speed sensors, and at a third controller of the electromechanical brake, when failures of the first controller and the second controller are identified, performing braking control for the electromechanical brake based on the pedal displacement signal or at least one among wheel speed signals output from the plurality of wheel speed sensors.

The method may further include, at the plurality of wheel speed sensors, respectively outputting the wheel speed signals through a first channel and a second channel and outputting the wheel speed signals to the first controller through the first channel, at the wheel speed sensor provided on the first wheel, outputting the wheel speed signal to the second controller through the second channel, and at the wheel speed sensor provided on the second wheel, outputting the wheel speed signal to the third controller through the second channel.

The method may further include, at the first controller, performing braking control for the hydraulic brake and the electromechanical brake by receiving the wheel speed signal from at least one of the second controller and the third controller based on identification of a failure of the first channel.

The method may further include, at the second controller, performing braking control for the hydraulic brake and the electromechanical brake by receiving the wheel speed signal from the third controller based on identification of a failure of the second channel.

The method may further include, at the first controller, when a failure of the wheel speed sensor provided on the second wheel is identified, performing braking control for the hydraulic brake and the electromechanical brake based on a wheel speed signal output from the wheel speed sensor provided on the first wheel.

The brake system may further include a first communication network connecting the first controller and the second controller, a second communication network connecting the first controller and the third controller, a third communication network connecting the second controller and the third controller, and a fourth communication network connecting the electromechanical brake provided on the second wheel, and the method may further include, at each of the first controller and the second controller, identifying a state of another party through the first communication network, at each of the first controller and the third controller, identifying a state of another party through the second communication network, and at each of the second controller and the third controller, identifying a state of another party through the third communication network.

The second communication network and the third communication network may be connected in parallel to the fourth communication network, and the method may further include, at the first controller or the second controller, selectively connecting to the fourth communication network through the second communication network or the third communication network based on an identified state of another party.

The brake system may further include a hydraulic pressure supply module configured to supply hydraulic pressure to the hydraulic brake, and the method may further include, in at least one of the first controller and the second controller, controlling the hydraulic pressure supply module to supply hydraulic pressure to the hydraulic brake.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows a configuration of a vehicle according to an embodiment of the disclosure;

FIG. 2 shows a connection relationship between components included in a brake system according to an embodiment of the disclosure;

FIG. 3 shows hydraulic and electrical control of a brake system according to an embodiment of the disclosure;

FIG. 4 shows a structure of a hydraulic pressure supply module included in a brake system according to an embodiment of the disclosure;

FIG. 5 shows an example of an electromechanical brake according to an embodiment of the disclosure;

FIG. 6 shows a connection relationship between components included in a brake system according to another embodiment of the disclosure;

FIG. 7 shows a configuration of a brake system according to another embodiment of the disclosure;

FIG. 8 shows a connection relationship between components included in a brake system according to another embodiment of the disclosure; and

FIG. 9 shows a control method of a brake system according to an embodiment of the disclosure.

### DETAILED DESCRIPTION

Like reference numerals refer to like components throughout the specification. This specification does not describe all components of embodiments, and duplicative contents between embodiments or general contents in the technical field to which the disclosure belongs will be omitted. The terms ‘portion,’ ‘module,’ ‘member,’ and ‘block’ used in this specification may be embodied as software or hardware, and it is also possible for a plurality of ‘portions,’ ‘modules,’ ‘members,’ and ‘blocks’ to be embodied as one component, or one ‘portion,’ ‘module,’ ‘member,’ and ‘block’to include a plurality of components according to embodiments.

Throughout the specification, when a portion is referred to as being ‘connected’ to another portion, it includes not only a direct connection but also an indirect connection, and the indirect connection includes connecting through a wireless network.

Also, when it is described that a portion ‘includes’ a component, it means that the portion may further include other components, not excluding the other components unless specifically stated otherwise.

Throughout the specification, when a member is described as being ‘on’ another member, this includes not only a case in which the member is in contact with the other member but also a case in which another member is present between the two members.

The terms ‘first,’ ‘second,’ etc. are used to distinguish one component from another component, and the components are not limited by the above-mentioned terms.

The singular forms ‘a,’ ‘an,’ and ‘the’ include plural referents unless the context clearly dictates otherwise.

In each step, an identification numeral is used for convenience of description, the identification numeral does not describe the order of the steps, and each step may be performed differently from the order specified unless the context clearly states a particular order.

Hereinafter, the operation principle and embodiments of the disclosure will be described with reference to the accompanying drawings.

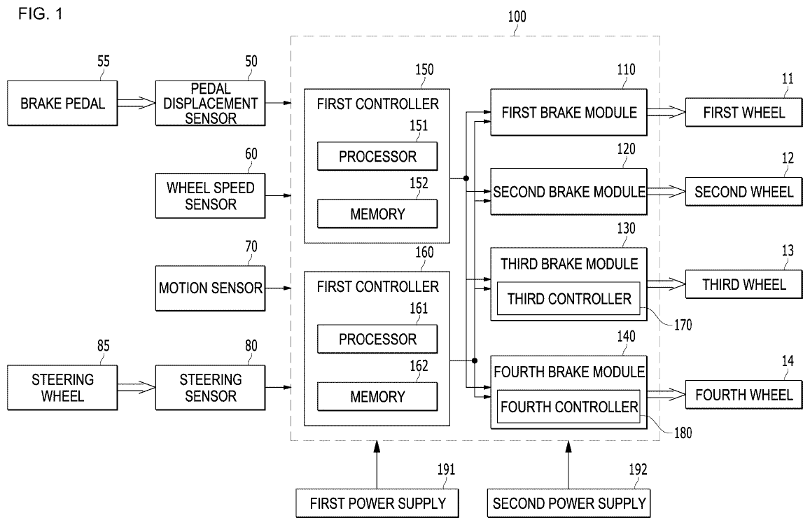

FIG. 1 shows a configuration of a brake system according to an embodiment of the disclosure and a vehicle related to the brake system.

Referring to FIG. 1, a vehicle 1 may include a plurality of wheels 11, 12, 13, and 14 that rotate to move the vehicle 1, a brake pedal 55 that obtains a driver's input for braking, a pedal displacement sensor 50 that detects a movement of the brake pedal 55, a wheel speed sensor 60 that detects rotation speeds of the plurality of wheels 11, 12, 13, and 14, a motion sensor 70 that detects a motion of the vehicle 1, a steering sensor 80 that detects a rotation of a steering wheel 85, and a brake system 100 that provides a braking force for stopping the vehicle 1 to the plurality of wheels 11, 12, 13 and 14. The pedal displacement sensor 50, the wheel speed sensor 60, the motion sensor 70, and the steering sensor 80 may not be essential components, and all or at least some of the above-mentioned components may be omitted.

The plurality of wheels 11, 12, 13, and 14 may include, for example, a first wheel 11 provided at a front left side of the vehicle 1, a second wheel 12 provided at a front right side of the vehicle 1, a third wheel 13 provided at a rear left side of the vehicle 1, and/or a fourth wheel 14 provided at a rear right side of the vehicle 1. However, the number of the plurality of wheels 11, 12, 13, and 14 is not limited to four.

The brake pedal 55 may be provided in a lower area of a cabin to enable a driver to control the brake pedal 55 with his/her foot. The driver may step on the brake pedal 55 with a braking intention to brake the vehicle 1. The brake pedal 55 may depart from a reference position according to the driver's intention to brake, and move.

The pedal displacement sensor 50 may be installed around the brake pedal 55 and measure a movement of the brake pedal 55 by the driver's intention to brake. For example, the pedal displacement sensor 50 may detect a movement distance of the brake pedal 55 from the reference position and/or a movement speed of the brake pedal 55.

The pedal displacement sensor 50 may be electrically connected to the brake system 100 and provide an electrical signal to the brake system 100. For example, the pedal displacement sensor 50 may be connected to the brake system 100 directly through a hard wire or through a communication network. Also, the pedal displacement sensor 50 may provide an electrical signal corresponding to a movement distance and/or movement speed of the brake pedal 55 to the brake system 100. Also, the pedal displacement sensor 50 may be integrated into the brake system 100.

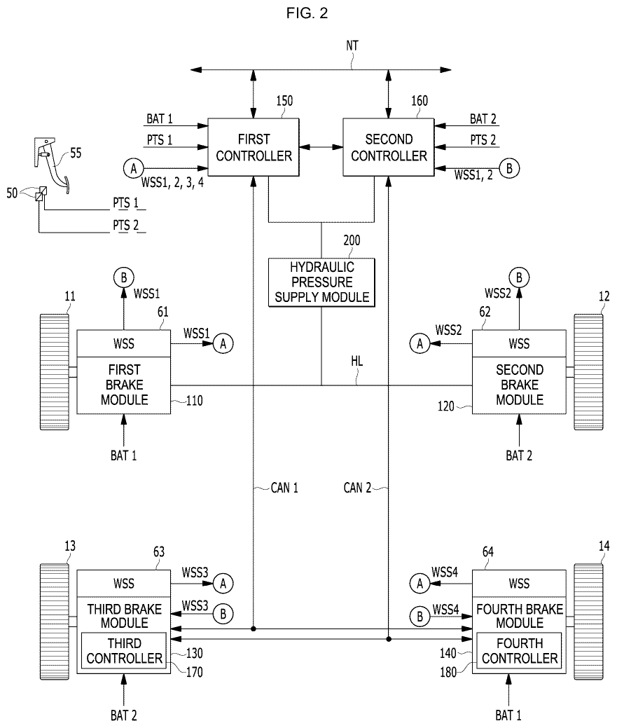

Referring to FIG. 2, a plurality of wheel speed sensors 61, 62, 63, and 64 may respectively output wheel speed signals representing rotation speeds of the plurality of wheels 11, 12, 13, and 14 through a first channel A and a second channel B, and provide the wheel speed signals to at least one of a first controller 150, a second controller 160, a third controller 170, and a fourth controller 180.

More specifically, the plurality of wheel speed sensors 61, 62, 63, and 64 may output wheel speed signals through the first channel A to provide the wheel speed signals to the first controller 150, and may additionally provide the wheel speed signals to at least one of the second controller 160, the third controller 170, and the fourth controller 180 through the second channel B in order to implement redundancy.

For example, the wheel speed sensors 61 and 62 respectively installed on front wheels 11 and 12 may provide wheel speed signals to the first controller 150 and the second controller 160 through the first channel A and the second channel B. Also, the wheel speed sensors 63 and 64 respectively installed on rear wheels 13 and 14 may provide wheel speed signals to the third controller 170 and the fourth controller 180 through the first channel A and the second channel B. However, the plurality of wheel speed sensors 61, 62, 63, and 64 are not limited thereto. For example, the wheel speed sensors 61 and 62 respectively installed on the front wheels 11 and 12 may provide wheel speed signals to the third controller 170 and the fourth controller 180 according to a design, and the wheel speed sensors 63 and 64 respectively installed on the rear wheels 13 and 14 may provide wheel speed signals to the first controller 150 and the second controller 160.

A first power supply 191 may include a power network capable of supplying power to the brake system 100.

A second power supply 192 may include a power network provided separately from the first power supply 191 and supply power to the brake system 100.

The first power supply 191 and the second power supply 192 may include separate power circuits that provide power from different batteries, or separate power circuits diverging from a single battery. For example, the first power supply 191 may include a first power circuit that provides power from a first battery, and the second power supply 192 may include a second power circuit that provides power from a second battery. Alternatively, the first power supply 191 and the second power supply 192 may respectively include a first power circuit and a second power circuit that provide power from a single battery.

The brake system 100 may include a plurality of brake modules 110, 120, 130, and 140 respectively installed on the plurality of wheels 11, 12, 13, and 14, and brake controllers 150 and 160 that respectively control the plurality of brake modules 110, 120, 130, and 140.

The plurality of brake modules 110, 120, 130, and 140 may respectively control the plurality of wheels 11, 12, 13, and 14 and brake the vehicle 1. For example, the plurality of brake modules 110, 120, 130, and 140 may include a first brake module 110 for braking the first wheel 11, a second brake module 120 for braking the second wheel 12, a third brake module 130 for braking the third wheel 13, and/or a fourth brake module 140 for braking the fourth wheel 14. However, the number of the plurality of brake modules 110, 120, 130, and 140 is not limited to four.

The first brake module 110 and the second brake module 120 may be provided as hydraulic brakes that operates by hydraulic pressure to brake the first wheel 11 and the second wheel 12 which are the front wheels. With regard to this, the brake system 100 may include a hydraulic pressure supply module 200 that provides hydraulic pressure to the first brake module 110 and the second brake module 120 through a hydraulic pressure line HL.

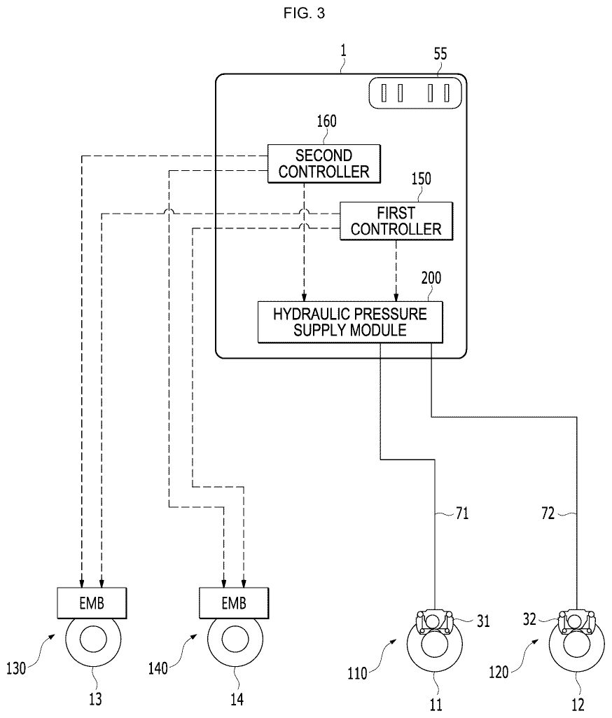

Referring to FIG. 3, the hydraulic pressure supply module 200 may generate hydraulic pressure for braking the first wheel 11 and the second wheel 12 which are the front wheels and provide the hydraulic pressure to the first brake module 110 and the second brake module 120. The hydraulic pressure supply module 200 may receive an output signal from the pedal displacement sensor 50 and confirm a driver's intention to brake. Also, the hydraulic pressure supply module 200 may generate hydraulic pressure based on a movement distance and/or movement speed of the brake pedal 55, and provide the generated hydraulic pressure to wheel cylinders 31 and 32 of the front wheels 11 and 12 through transfer flow paths 71 and 72.

Internal pressure of the wheel cylinders 31 and 32 of the front wheels 11 and 12 may depend on hydraulic pressure provided from the hydraulic pressure supply module 200. The front wheels 11 and 12 may respectively generate braking forces depending on internal pressure of the wheel cylinders 31 and 32.

The hydraulic pressure supply module 200 may include a reservoir 210 in which a pressing medium is stored, a master cylinder 220 that provides a reaction force corresponding to a pedal effort of the brake pedal 55 to a driver and simultaneously presses and discharges the pressing medium such as brake oil accommodated in the master cylinder 220, a hydraulic pressure supply unit 230 that receives a driver's intention to brake as an electrical signal from the pedal displacement sensor 50 for detecting a displacement of the brake pedal 55 and generates hydraulic pressure of the pressing medium through a mechanical operation, a hydraulic pressure control unit 240 that controls the hydraulic pressure provided from the hydraulic pressure supply unit 230, a hydraulic pressure circuit 250 including the wheel cylinders 31 and 32 that receive the hydraulic pressure of the pressing medium to brake the respective front wheels 11 and 12, a backup flow path 271 that hydraulically connects the master cylinder 220 and the hydraulic circuit 250, a dump control unit 280 provided between the hydraulic pressure supply unit 230 and the reservoir 210 to control flow of the pressing medium, reservoir flow paths 211 and 212 that hydraulically connect the reservoir 210 and the master cylinder 220, and an inspection flow path 290 connected to a master chamber of the master cylinder 220.

The reservoir 210, the master cylinder 220, the hydraulic pressure supply unit 230, the hydraulic pressure control unit 240, the hydraulic circuit 250, the backup flow path 271, the dump control unit 280, the reservoir flow paths 211 and 212, and the inspection flow path 290 may not be essential components, and all or at least some of the above-mentioned components may be omitted.

The reservoir 210 may accommodate and/or store a pressing medium therein. The reservoir 210 may be connected to the master cylinder 220, the hydraulic pressure supply unit 230, and/or the hydraulic circuit 250 to supply or receive the pressing medium.

The reservoir flow paths 211 and 212 may include a first reservoir flow path 211 that connects the reservoir 210 to a first master chamber 222a of the master cylinder 220, and a second reservoir flow path 212 that connects the reservoir 210 to a second master chamber 223 of the master cylinder 220. The first reservoir flow path 211 may be provided with a simulator valve 211a to control flow of the pressing medium between the reservoir 210 and the first master chamber 222a through the first reservoir flow path 211.

When the driver applies a pedal effort to the brake pedal 55 to brake, the master cylinder 220 may provide a reaction force corresponding to the pedal effort to the driver to provide stable pedal feeling. Also, the master cylinder 220 may press and discharge the pressing medium accommodated therein according to an operation of the brake pedal 55.

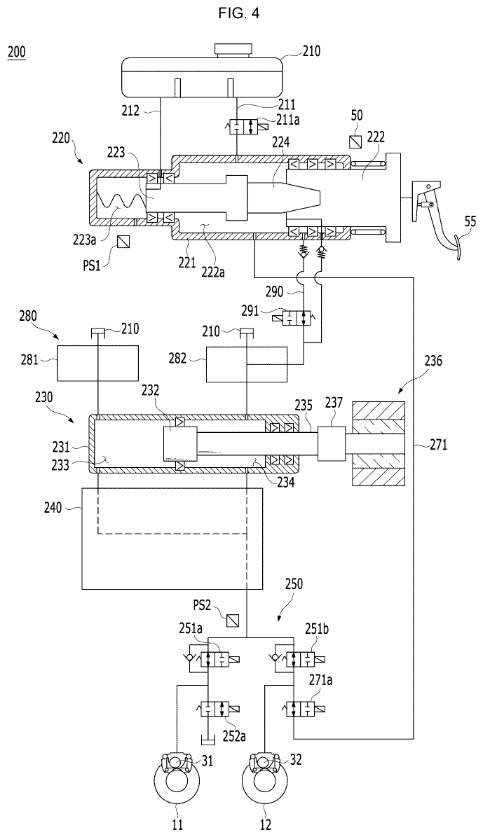

The master cylinder 220 may include a cylinder body 221 that forms a chamber therein, the first master chamber 222a formed at an inlet side of the cylinder body 221 to which the brake pedal 55 is connected, a first master piston 222 provided in the first master chamber 222a and connected to the brake pedal 55 to move by an operation of the brake pedal 55, a second master chamber 223a formed in an inner side of the cylinder body 221 than the first master chamber 222a or in a front direction (a left direction in FIG. 4) from the first master chamber 222a, a second master piston 223 provided in the second master chamber 223a and configured to move by a displacement of the first master piston 222 or hydraulic pressure of the pressing medium accommodated in the first master chamber 222a, and a pedal simulator 224 positioned between the first master piston 222 and the second master piston 223 and configured to provide pedal feeling through an elastic restoring force generated during compression.

The cylinder body 221, the first master chamber 222a, the first master piston 222, the second master chamber 223a, the second master piston 223, and the pedal simulator 224 may not be essential components, and all or at least some of the above-mentioned components may be omitted.

The first master piston 222 and the second master piston 223 may be respectively provided in the first master chamber 222a and the second master chamber 223a to form hydraulic pressure or negative pressure in the pressing medium accommodated in the first master chamber 222a and the second master chamber 223a according to a forward or backward movement.

The pedal simulator 224 may be provided between the first master piston 222 and the second master piston 223 to provide a driver with pedal feeling of the brake pedal 55 by an elastic restoring force.

The hydraulic pressure supply unit 230 may receive a driver's intention to brake as an electrical signal from the pedal displacement sensor 50 for detecting a displacement of the brake pedal 55, and generate hydraulic pressure of the pressing medium through a mechanical operation.

The hydraulic pressure supply unit 230 may include a cylinder block 231 in which the pressing medium is accommodated, a hydraulic piston 232 accommodated inside the cylinder block 231, pressure chambers 233 and 234 partitioned by the hydraulic piston 232 and the cylinder block 231, a hydraulic pressure generating motor 236 that generates a rotational force, a power conversion unit 237 that converts a rotational force of the hydraulic pressure generating motor 236 into a translational motion of the hydraulic piston 232, and a driving shaft 235 that transfers power to the hydraulic piston 232.

The cylinder block 231, the hydraulic piston 232, the pressure chambers 233 and 234, the hydraulic pressure generating motor 236, the power conversion unit 237, and the driving shaft 235 may not be essential components of the hydraulic pressure supply unit 230, and at least some of the above-mentioned components may be omitted.

The pressure chambers 233 and 234 may include a first pressure chamber 233 located in front of the hydraulic piston 232 (left direction from the hydraulic piston 232 in FIG. 4), and a second pressure chamber 234 located behind the hydraulic piston 232 (right direction from the hydraulic piston 232 in FIG. 4). That is, the first pressure chamber 233 may be partitioned by the cylinder block 231 and a front surface of the hydraulic piston 232 such that a volume of the first pressure chamber 233 changes according to a movement of the hydraulic piston 232. Also, the second pressure chamber 234 may be partitioned by the cylinder block 231 and a rear surface of the hydraulic piston 232 such that a volume of the second pressure chamber 234 changes according to a movement of the hydraulic piston 232.

When a displacement of the brake pedal 55 is detected by the pedal displacement sensor 50, the hydraulic piston 232 may move forward inside the cylinder block 231 to generate hydraulic pressure in the first pressure chamber 233 and generate negative pressure in the second pressure chamber 234. Conversely, when a pedal effort on the brake pedal 55 is released, the hydraulic piston 232 may move backward inside the cylinder block 231 to generate negative pressure in the first pressure chamber 233 and generate hydraulic pressure in the second pressure chamber 234.

As such, the hydraulic pressure supply unit 230 may generate hydraulic pressure or negative pressure in the first pressure chamber 233 and the second pressure chamber 234 by the hydraulic pressure generating motor 236.

The hydraulic pressure supply unit 230 may be hydraulically connected to the reservoir 210 by the dump control unit 280. The dump control unit 280 may include at least one flow path and at least one valve to control flow of the pressing medium between the hydraulic pressure supply unit 230 and the reservoir 210.

The hydraulic control unit 240 may control hydraulic pressure that is to be transferred to the wheel cylinders 31 and 32 of the front wheels 11 and 12.

The hydraulic control unit 240 may control flow of hydraulic pressure that is to be transferred to the first wheel cylinder 31 between the two wheel cylinders 31 and 32 of the front wheels 11 and 12, and be connected to the hydraulic circuit 250 that controls flow of hydraulic pressure that is to be transferred to the second wheel cylinder 32.

The hydraulic control unit 240 may include at least one flow path and at least one valve to guide hydraulic pressure supplied from the hydraulic pressure supply unit 230 to the hydraulic circuit 250.

The hydraulic control unit 240 may form a flow path for providing the pressing medium to the hydraulic circuit 250 by using pressure of the first pressure chamber 233 formed by a forward movement of the hydraulic piston 232. For example, the hydraulic control unit 240 may form a flow path connecting the first pressure chamber 233 to the hydraulic circuit 250. The pressing medium in the first pressure chamber 233 may be provided to the hydraulic circuit 250 through the hydraulic control unit 240.

The hydraulic control unit 240 may form a flow path for providing the pressing medium to the hydraulic circuit 250 by using pressure of the second pressure chamber 234 formed by a backward movement of the hydraulic piston 232. For example, the hydraulic control unit 240 may form a flow path connecting the second pressure chamber 234 to the hydraulic circuit 250. The pressing medium in the second pressure chamber 234 may be provided to the hydraulic circuit 250 through the hydraulic control unit 240.

The hydraulic control unit 240 may form a flow path for retrieving the pressing medium from the hydraulic circuit 250 by using negative pressure of the first pressure chamber 233 formed by a backward movement of the hydraulic piston 232. For example, the hydraulic control unit 240 may connect the hydraulic circuit 250 to the first pressure chamber 233, and form a flow path connecting the hydraulic circuit 250 and the first pressure chamber 233. The pressing medium in the hydraulic circuit 250 may be provided to the first pressure chamber 233 through the hydraulic control unit 240.

The hydraulic control unit 240 may form a flow path for retrieving the pressing medium from the hydraulic circuit 250 by using negative pressure of the second pressure chamber 234 formed by a forward movement of the hydraulic piston 232. For example, the hydraulic control unit 240 may connect the hydraulic circuit 250 to the second pressure chamber 234, and form a flow path connecting the hydraulic circuit 250 and the second pressure chamber 234. The pressing medium in the hydraulic circuit 250 may be provided to the second pressure chamber 234 through the hydraulic control unit 240.

The hydraulic circuit 250 may adjust and/or control hydraulic pressure applied to the first wheel cylinder 31 and hydraulic pressure applied to the second wheel cylinder 32.

The hydraulic circuit 250 may include a first inlet valve 251a to control flow and hydraulic pressure of the pressing medium transferred to the first wheel cylinder 31. The first inlet valve 251a may be positioned at an upstream side of the first wheel cylinder 31, and provided as a normal open type solenoid valve.

The hydraulic circuit 250 may include a second inlet valve 251b to control flow and hydraulic pressure of the pressing medium transferred to the second wheel cylinder 32. The second inlet valve 251b may be positioned at an upstream side of the second wheel cylinder 32, and provided as a normal open type solenoid valve.

The hydraulic circuit 250 may include an outlet valve 252a to control flow of the pressing medium discharged from the first wheel cylinder 31 in order to improve performance while braking of the first wheel cylinder 31 is released. The outlet valve 252a may be provided at an outlet side of the first wheel cylinder 31 to control flow of the pressing medium transferred from the first wheel cylinder 31 to the reservoir 210. The outlet valve 252a may be provided as a normal close type solenoid valve.

The second wheel cylinder 32 may be connected to the backup flow path 271, and the backup flow path 271 may be provided with at least one cut valve 271a to control flow of the pressing medium between the second wheel cylinder 31 and the master cylinder 220. However, a connection structure of the backup flow path 271 is not limited thereto. For example, the backup flow path 271 may be connected to the first wheel cylinder 31. Also, the backup flow path 271 may be connected to the first wheel cylinder 31 and the second wheel cylinder 32. As such, the backup flow path 271 may be connected to at least one of the first wheel cylinder 31 and the second wheel cylinder 32.

When the hydraulic pressure supply module 200 fails to operate normally due to a failure, etc., the backup flow path 271 may transfer hydraulic pressure of the master cylinder 220 directly to the wheel cylinders 31 and 32 of the front wheels 11 and 12 in an abnormal operation mode, that is, a fallback mode. For example, the backup flow path 271 may connect the first master chamber 222a of the master cylinder 220 to the hydraulic circuit 250.

The cut valve 271a may be provided as a normal open type solenoid valve to control bidirectional flow of the pressing medium in the backup flow path 271. While the cut valve 271a is in a closed state, the pressing medium in the master cylinder 220 may be prevented from being transferred directly to the wheel cylinders 31 and 32 of the front wheels 11 and 12, and simultaneously, hydraulic pressure provided from the hydraulic pressure supply unit 230 may be prevented from leaking to the master cylinder 220. Also, while the cut valve 271a is in an open state, the pressing medium pressed in the master cylinder 220 may be supplied directly to the hydraulic circuit 250 through the backup flow path 271.

Also, the inspection flow path 290 may connect the master cylinder 220 to the dump control unit 280 to inspect various components installed in the master cylinder 220 and leakage of the simulator valve 211a.

The hydraulic pressure supply module 200 may include a first pressure sensor PS1 that measures hydraulic pressure provided by the master cylinder 220, and a second pressure sensor PS2 that measures hydraulic pressure of the pressing medium provided by the hydraulic pressure supply unit 230. The first pressure sensor PS1 and the second pressure sensor PS2 may output electrical signals representing measured pressure.

The third brake module 130 and the fourth brake module 140 may be provided as electromechanical brakes that operate by an electro-mechanical force in order to respectively brake the third wheel 13 and the forth wheel 14 which are the rear wheels.

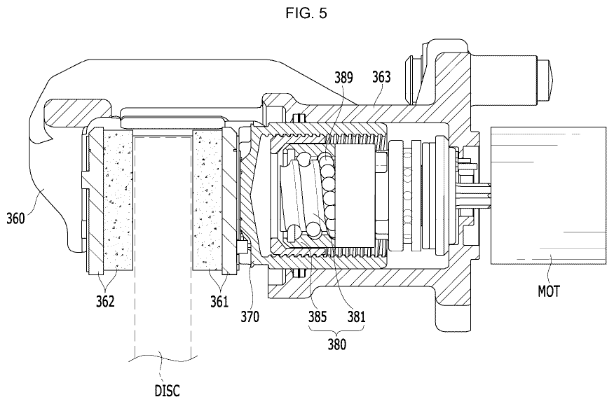

The third brake module 130 and the fourth brake module 140 may operate based on brake control signals output from the brake controllers 150 and 160, without being mechanically or hydraulically connected to the brake pedal 55. For example, the third brake module 130 and the fourth brake module 140 may include caliper brakes, as shown in FIG. 5.

FIG. 5 shows an example of an electromechanical brake according to an embodiment of the disclosure.

A caliper brake may include a pair of pad plates 361 and 362 installed to press a brake disc DISC rotating together with the third wheel 13 and the fourth wheel 14, a caliper housing 360 that operates the pair of pad plates 361 and 362, a piston 370 installed inside the caliper housing 360 in such a way as to move back and forth, a power conversion unit 380 that receives a rotational driving force for moving the piston 370, converts the rotational driving force into a linear driving force, and transfer the linear driving force to the piston 370, and a brake motor MOT that generates a rotational driving force for moving the piston 370. The pair of pad plates 361 and 362, the caliper housing 360, the piston 370, the power conversion unit 380, and the brake motor MOT may not be essential components, and all or at least some of the above-mentioned components may be omitted.

The piston 370 may have a cup shape of which a rear side (right side in FIG. 5) opens, and may be inserted in a cylinder 363 in such a way as to slidingly move inside the cylinder 363. Also, the piston 370 may receive power from the power conversion unit 380 and press an inner pad plate 361 toward the brake disc DISC.

The power conversion unit 380 may include a spindle 381 that rotates by receiving a driving force from the brake motor MOT, a nut 385 positioned inside the piston 370 and screwed to the spindle 381 to move forward together with the piston 370 according to a rotation in first direction of the spindle 381 or move backward together with the piston 370 according to a rotation in second direction of the spindle 381, and a plurality of balls 389 interposed between the spindle 381 and the nut 385. The power conversion unit 380 may be provided as a ball-screw type conversion device that converts a rotational motion of the spindle 381 into a linear motion.

A rotation motion of the brake motor MOT may be converted into a linear motion of the piston 370 by the power conversion unit 380. By the linear motion of the piston 370, the pair of pad plates 361 and 362 may be compressed toward the brake disc DISC, and by friction between the pair of pad plates 361 and 362 and the brake disc DISC, the third wheel 13 and the fourth wheel 14 may be braked.

FIG. 5 shows a caliper brake as an example of an electromechanical brake. However, the electromechanical brake is not limited to a caliper brake. For example, the electromechanical brake may be a drum brake.

Referring again to FIG. 1, the brake controller 150 or 160 may receive output signals from the pedal displacement sensor 50, the wheel speed sensor 60, the motion sensor 70, and/or the steering sensor 70, and perform braking control of the plurality of brake modules 110, 120, 130, and 140.

The brake controller 150 or 160 may provide a brake control signal to the plurality of brake modules 110, 120, 130, and 140 to brake the vehicle 1 based on an electrical signal output from the pedal displacement sensor 50. For example, the brake controller 150 or 160 may identify a braking force (or deacceleration) for braking the vehicle 1 based on an output signal from the pedal displacement sensor 50 and provide a brake control signal corresponding to the identified braking force (or deacceleration) to the plurality of brake modules 110, 120, 130, and 140.

The brake controller 150 or 160 may distribute a braking force to the plurality of brake modules 110, 120, 130, and 140 to brake the vehicle based on an electrical signal output from the pedal displacement sensor 50. For example, the brake controller 150 or 160 may distribute a driver's requested braking force to the plurality of brake modules 110, 120, 130, and 140 and provide a brake control signal corresponding to a braking force distributed to each of the plurality of brake modules 110, 120, 130, and 140. With regard to this, the brake system 100 may include electronic brake force distribution (EBD).

The brake controller 150 or 160 may provide a brake control signal to the plurality of brake modules 110, 120, 130, and 140 to temporarily allow rotations of the plurality of wheels 11, 12, 13, and 14 based on an electrical signal output from the wheel speed sensor 60. For example, while the brake controller 150 or 160 brakes the vehicle 1, the brake controller 150 or 160 may identify a slip of all or a part of the plurality of wheels 11, 12, 13, and 14, based on an output signal from the wheel speed sensor 60. To relieve the slip of the plurality of wheels 11, 12, 13, and 14 in response to the slip of the plurality of wheels 11, 12, 13, and 14, the brake controller 150 or 160 may provide a brake control signal for temporarily allowing rotations of the plurality of wheels 11, 12, 13, and 14 to the plurality of brake modules 110, 120, 130, and 140. With regard to this, the brake system 100 may include an anti-lock braking system (ABS).

The brake controller 150 or 160 may provide a brake control signal to the plurality of brake modules 110, 120, 130, and 140 in order to temporarily brake the plurality of wheels 11, 12, 13, and 14 based on an electrical signal output from the wheel speed sensor 60 without receiving a user's intention to brake. For example, the brake controller 150 or 160 may identify a spin of the plurality of wheels 11, 12, 13, and 14 based on an output signal from the wheel speed sensor 60 while the vehicle 1 travels. To relieve the spin of the plurality of wheels 11, 12, 13, and 14 in response to the spin of the plurality of wheel 11, 12, 13, and 14, the brake controller 150 or 160 may provide a brake control signal for temporarily braking the plurality of wheels 11, 12, 13, and 14 to the plurality of brake modules 110, 120, 130, and 140. With regard to this, the brake system 100 may include a traction control system (TCS).

The brake controller 150 or 160 may provide a brake control signal to the plurality of brake modules 110, 120, 130, and 140 to temporarily brake the plurality of wheels 11, 12, 13, and 14 based on an electrical signal output from the motion sensor 70 and/or the steering sensor 80 without receiving a user's intention to brake. For example, the brake controller 150 or 160 may identify a reference path (reference rotation driving path) of the vehicle 1 based on an output signal from the steering sensor 80 during steering of the vehicle 1, and identify a driving path (rotation driving path) of the vehicle 1 based on an output signal from the motion sensor 70 during steering of the vehicle 1. The brake controller 150 or 160 may identify oversteering or understeering of the vehicle 1 based on a reference path and a driving path. The brake controller 150 or 160 may provide a brake control signal for temporarily braking the plurality of wheels 11, 12, 13, and 14 to the plurality of brake modules 110, 120, 130, and 140 based on oversteering and/or understeering. With regard to this, the brake system 100 may include electronic stability control (ESC).

The brake controller 150 or 160 may provide a parking signal to the plurality of brake modules 110, 120, 130, and 140 in response to a parking command from a driver to prevent the plurality of wheels 11, 12, 13, and 14 from rotating. With regard to this, the brake system 100 may include an electronic parking brake (EPB).

The brake controllers 150 and 160 may include a plurality of processors 151 and 152 to prepare for damage and/or errors of an electrical system and stably perform set functions. For example, the brake controllers 150 and 160 may include the first controller 150 and the second controller 160. The second controller 160 may be provided as a reserve and may not be an essential component. Therefore, the second controller 160 may be omitted.

The first controller 150 and the second controller 160 may include a plurality of semiconductor devices and may be called various names, such as Brake Control Unit (BCU) and Electronic Control Unit (ECU). The first controller 150 and the second controller 160 may include, for example, a plurality of processors and/or a plurality of memories. For example, the first controller 150 may include a processor 151 and a memory 152. Also, the second controller 160 may include a processor 161 and a memory 162. The above-described components may not be essential components of the brake system 100, and at least some of the above-described components may be omitted.

The processors 151 and 161 may provide a control signal for controlling operations of components included in the brake system 100 according to a driver's intention to brake.

The memories 152 and 162 may memorize or store programs and data for implementing operations of controlling the components included in the brake system 100.

The memories 152 and 162 may provide the stored programs and data to the processors 151 and 161 and memorize temporary data generated while the processors 151 and 161 operate. For example, the memories 152 and 162 may include a volatile memory, such as Static Random Access Memory (S-RAM) and Dynamic Random Access Memory (D-RAM), and a non-volatile memory, such as Read Only Memory (ROM), Erasable Programmable Read Only Memory (EPROM), and flash memory.

Referring again to FIG. 2, the first controller 150 may perform a set operation based on an output signal from the pedal displacement sensor 50 and/or the wheel speed sensor 60. Also, the first controller 150 may identify a braking force (or deacceleration or a clamping force) corresponding to a service brake, EBD, ABS, TCS, EPB, etc. based on the performed operation, and output a brake control signal corresponding to the braking force to all or some of the plurality of brake modules 110, 120, 130, and 140.

The first controller 150 may receive a first pedal displacement signal PTS 1 from the pedal displacement sensor 50 and receive first to fourth wheel speed signals WSS1, WSS2, WSS3, and WSS4 from first to fourth wheel speed sensors 61, 62, 63, and 64. Also, the first controller 150 may be connected to a vehicle communication network NT which is a first communication network. For example, the first controller 150 may receive a yaw rate signal representing a yaw rate of the vehicle 1 from the motion sensor 70 and receive a steering angle signal representing a steering angle of the vehicle 1 from the steering sensor 80, through the vehicle communication network NT.

The first controller 150 may control the hydraulic pressure supply module 200 that provides hydraulic pressure to the first brake module 110 and the second brake module 120 in order to brake the first wheel 11 and the second wheel 12.

Also, the first controller 150 may be connected to the third brake module 130 and the fourth brake module 140 through a second communication network CAN 1, and communicate with the third brake module 130 and the fourth brake module 140.

The second communication network CAN 1 may be set to, for example, a dedicated communication network that is separated and independent from the vehicle communication network NT. Because the second communication network CAN 1 is separated and independent from the vehicle communication network NT, a brake control signal generated by the first controller 150 may be more quickly transferred to the third brake module 130 and the fourth brake module 140.

The second communication network CAN 1 may use various communication methods, such as the Ethernet, Media Oriented Systems Transport (MOST), Flexray, Controller Area Network (CAN), Local Interconnect Network (LIN), etc.

The first controller 150 may communicate with the second controller 160. For example, the first controller 150 may periodically transmit a state signal to the second controller 160. Based on reception of a periodic state signal from the first controller 150, the second controller 160 may identify a normal operation state of the first controller 150.

When the first controller 150 does not operate normally, the first controller 150 may not transmit a periodic state signal to the second controller 160. The second controller 160 may identify an abnormal operation state (for example, damage, error, reset, power interruption, etc.) of the first controller 150 based on a failure in receiving a periodic state signal from the first controller 150 at a set time.

Based on the identification of the abnormal operation state (for example, damage, error, reset, power interruption, etc.) of the first controller 150, the second controller 160 may output an electrical signal corresponding to the service brake, EBD, ABS, TCS, ESC, EPB, etc. to the plurality of brake modules 110, 120, 130, and 140.

The second controller 160 may perform a set operation based on an output signal from the pedal displacement sensor 50, the wheel speed sensor 60, the motion sensor 50, and/or the steering sensor 70. Also, the second controller 160 may identify a braking force corresponding to the service brake, EBD, ABS, TCS, ESC, EPB, etc. based on the performed operation. However, while the first controller 150 operates normally, the second controller 160 may not output a brake control signal to the plurality of brake modules 110, 120, 130, and 140, the plurality of brake modules 110, 120, 130, and 140 may not receive a brake control signal from the second controller 160, or the plurality of brake modules 110, 120, 130, and 140 may ignore a brake control signal from the second controller 160.

The second controller 160 may receive a second pedal displacement signal PTS 2 from the pedal displacement sensor 50 and receive first and second wheel speed signals WSS1 and WSS2 from the first and second wheel speed sensors 61 and 62. Also, the second controller 160 may be connected to the vehicle communication network NT. For example, the second controller 160 may receive a yaw rate signal representing a yaw rate of the vehicle from the motion sensor 70 and a steering angle signal representing a steering angle of the vehicle 1 from the steering sensor 80, through the vehicle communication network NT.

The second controller 160 may provide a brake control signal representing a braking torque (or a braking force, deacceleration, or a clamping force) to each of the first to fourth brake modules 110, 120, 130, and 140. For example, the second controller 160 may identify a driver's requested braking torque based on the second pedal displacement signal PTS 2, and distribute the driver's requested braking torque to the first to fourth brake modules 110, 120,130, and 140.

The second controller 160 may control the hydraulic pressure supply module 200 that provides hydraulic pressure to the first brake module 110 and the second brake modules 120 in order to brake the first wheel 11 and the second wheel 12.

Also, the second controller 160 may be connected to the third brake module 130 and the fourth brake module 140 through a third communication network CAN 2, and communicate with the third brake module 130 and the fourth brake module 140.

The third communication network CAN 2 may be set to, for example, a dedicated communication network that is separated and independent from the vehicle communication network NT. Because the third communication network CAN 2 is separated and independent from the vehicle communication network NT, a brake control signal generated by the second controller 160 may be more quickly transferred to the third brake module 130 and the fourth brake module 140.

The third communication network CAN 2 may use various communication methods, such as the Ethernet, MOST, Flexray, CAN, LIN, etc.

The second controller 160 may communicate with the first controller 150. For example, the second controller 160 may periodically transmit an electrical signal to the first controller 150. The first controller 150 may identify an operation state (for example, a normal state or a failure state) of the second controller 160 based on whether a periodic state signal has been received from the second controller 160. Also, the second controller 160 may periodically receive a state signal from the first controller 150, and identify a normal state of the first controller 150 based on the received state signal. When the second controller 160 fails to periodically receive a state signal from the first controller 150, the second controller 160 may identify a failure state of the first controller 150 based on reception interruption of the state signal.

The second controller 160 may be implemented as semiconductor devices provided separately from the first controller 150. Alternatively, the second controller 160 may be implemented with processing cores provided at a separate area in the same semiconductor device as the first controller 150.

The second controller 160 may have the same computation capability as the first controller 150 or lower computation capability than the first controller 150. For example, the number of instructions capable of being processed per unit time by the second controller 160 may be equal to or smaller than the number of instructions capable of being processed per unit time by the first controller 150.

The brake controllers 150 and 160 may be configured such that the second controller 160 controls the plurality of brake modules 110, 120, 130, and 140 while the first controller 150 fails, and the first controller 150 controls the plurality of brake modules 110, 120, 130, and 140 while the second controller 160 fails.

The pedal displacement sensor 50 may include a first pedal displacement sensor 50 and a second pedal displacement sensor 50 to prepare for damage or errors of the electrical system.

The first pedal displacement sensor 50 and the second pedal displacement sensor 50 may detect a movement of the brake pedal 55, and output an electrical output signal (PTS1 or PTS2) corresponding to the movement (for example, a movement displacement or moving speed) of the brake pedal 55 to the first controller 150 and the second controller 160. For example, the first pedal displacement sensor 50 may be electrically connected to the first controller 150 and output a first pedal displacement signal PTS1 to the first controller 150. The second pedal displacement sensor 50 may be electrically connected to the second controller 160 and output a second pedal displacement signal PTS2 to the second controller 160

The wheel speed sensor 60 may include the plurality of wheel speed sensors 61, 62, 63, and 64 respectively installed on the plurality of wheels 11, 12, 13, and 14. For example, the wheel speed sensor 60 may include the first to fourth wheel speed sensors 61, 62, 63, and 64.

The first to fourth wheel speed sensors 61, 62, 63, and 64 may independently detect rotation speeds of the first to fourth wheels 11, 12, 13, and 14, respectively. Also, the first to fourth wheel speed sensors 61, 62, 63, and 64 may be electrically connected to the brake system 100, and output electrical signals WSS1, WSS2, WSS3, and WSS4 corresponding to rotation speeds of the first to fourth wheels 11, 12, 13, and 14 to the brake controllers 150 and 160.

The first to fourth wheel speed sensors 61, 62, 63, and 64 may respectively output first to fourth wheel speed signals WSS1, WSS2, WSS3, and WSS4 through multiple channels to prepare for damage or errors of the electrical system.

For example, the first to fourth wheel speed sensors 61, 62, 63, and 64 may respectively output first to fourth wheel speed signals WSS1, WSS2, WSS3, and WSS4 corresponding to rotation speeds of the first to fourth wheels 11, 12, 13, and 14 to the first controller 150 through the first channel A. The first controller 150 may receive the first to fourth wheel speed signals WSS1, WSS2, WSS3, and WSS4 output from the first to fourth wheel speed sensors 61, 62, 63, and 64 through the first channel A.

Also, the first wheel speed sensor 61 and the second wheel speed sensor 62 may output a first wheel speed signal WSS1 and a second wheel speed signal WSS2, respectively, to the second controller 160 through the second channel B. Also, the third wheel speed sensor 63 and the fourth wheel speed sensor 64 may output a third wheel speed signal WSS3 and a fourth wheel speed signal WSS4, respectively, to the third brake module 130 and the fourth brake module 140 to prepare for damage or errors of the electrical system. The first to fourth wheel speed sensors 61, 62, 63, and 64 may output wheel speed signals through a plurality of channels such that vehicle safety is not affected even in the event of a failure such as a short circuit.

The third brake module 130 and the fourth brake module 140 may respectively include the third controller 170 and the fourth controller 180 that perform control of braking the third wheel 13 and the fourth wheel 14 with an electromechanical force based on a brake control signal output from the brake controller 150 or 160.

The third controller 170 and the fourth controller 180 may respectively receive a third wheel speed signal WSS3 and a fourth wheel speed signal WSS4 output from the third wheel speed sensor 63 and the fourth wheel speed sensor 64.

At least one of the third controller 170 and the fourth controller 180 may receive a state signal periodically from at least one of the first controller 150 and the second controller 160, and identify a normal state of the at least one of the first controller 150 and the second controller 160 based on the received state signal. When at least one of the third controller 170 and the fourth controller 180 fails to receive a state signal periodically from at least one of the first controller 150 and the second controller 160, the at least one of the third controller 170 and the fourth controller 180 may identify a failure state of the at least one of the first controller 150 and the second controller 160 based on reception interruption of the state signal.

The first controller 150, the second controller 160, the third controller 170, and the fourth controller 180 may respectively receive first to fourth wheel speed signals WSS1, WSS2, WSS3, and WSS4 from the first to fourth wheel speed sensors 61, 62, 63, and 64 through set channels, and perform braking control for the first to fourth brake modules 110, 120, 130, and 140 based on the received first to fourth wheel speed signals WSS1, WSS2, WSS3, and WSS4.

The first controller 150, the second controller 160, the third controller 170, and the fourth controller 180 may respectively identify communication states (for example, normal states or failure states) based on reception of first to fourth wheel speed signals WSS1, WSS2, WSS3, and WSS4 output from the first to fourth wheel speed sensors 61, 62, 63, and 64.

When the first controller 150 identifies a communication failure by failing to receive at least one of first to fourth wheel speed signals WSS1, WSS2, WSS3, and WSS4 from the first to fourth wheel speed sensors 61, 62, 63, and 64, the first controller 150 may perform braking control for the first to fourth brake modules 110, 120, 130, and 140 by using wheel speed signals received by the second controller 160, the third controller 170, and the fourth controller 180.

For example, when the first controller 150 identifies a communication failure by failing to receive at least one of a first wheel speed signal WSS1 and a second wheel speed signal WSS2 from at least one of the first wheel speed sensor 61 and the second wheel speed sensor 62, the first controller 150 may receive at least one of a first wheel speed signal WSS1 and a second wheel speed signal WSS2 from the second controller 160 that has received the at least one of the first wheel speed signal WS1 and the second wheel speed signal WSS2 from the at least one of the first wheel speed sensor 61 and the second wheel speed sensor 62, and output a brake control signal for controlling an operation of at least one of the first brake module 110 and the second brake module 120 based on the at least one of the first wheel speed signal WSS1 and the second wheel speed signal WSS2, to the at least one of the first brake module 110 and the second brake module 120.

Also, when the first controller 150 identifies a communication failure by failing to receive at least one of a third wheel speed signal WSS3 and a fourth wheel speed signal WSS4 from at least one of the third wheel speed sensor 63 and the fourth wheel speed sensor 64, the first controller 150 may receive at least one of a third wheel speed signal WSS3 and a fourth wheel speed signal WSS4 from at least one of the third controller 170 that has received the third wheel speed signal WSS3 from the third wheel speed sensor 63 and the fourth controller 180 that has received the fourth wheel speed signal WSS4 from the fourth wheel speed sensor 64, and output a brake control signal for controlling an operation of at least one of the third brake module 130 and the fourth brake module 140 based on the at least one of the third wheel speed signal WSS3 and the fourth wheel speed signal WSS4, to the at least one of the third brake module 130 and the fourth brake module 140. At least one of the third controller 170 and the fourth controller 180 may output a motor control signal based on a target brake torque received from the first controller 150 such that the third brake module 130 and the fourth brake module 140 generate an actual brake torque corresponding to the target brake torque.

When the first controller 150 identifies a communication failure by failing to receive at least one of first to fourth wheel speed signals WSS1, WSS2, WSS3, and WSS4 from the first to fourth wheel speed sensors 61, 62, 63, and 64, at least one of the second controller 160, the third controller 170, and the fourth controller 180 may perform braking control for the first to fourth brake modules 110, 120, 130, and 140, instead of the first controller 150.

For example, when the first controller 150 identifies a communication failure by failing to receive at least one of a first wheel speed signal WSS1 and a second wheel speed signal WSS2 from at least one of the first wheel speed sensor 61 and the second wheel speed sensor 62, the second controller 160 that has received at least one of a first wheel speed signal WSS1 and a second wheel speed signal WSS2 from at least one of the first wheel speed sensor 61 and the second wheel speed sensor 62 may output a brake control signal for controlling an operation of at least one of the first brake module 110 and the second brake module 120 to the at least one of the first brake module 110 and the second brake module 120, instead of the first controller 150.

Also, when the first controller 150 identifies a communication failure by failing to receive at least one of a third wheel speed signal WSS3 and a fourth wheel speed signal WSS4 from at least one of the third wheel speed sensor 63 and the fourth wheel speed sensor 64, the third controller 170 that has received a third wheel speed signal WSS3 from the third wheel speed sensor 63 may output a brake control signal for controlling an operation of the third brake module 130 to the third brake module 130, instead of the first controller 150, or the fourth controller 180 that has received a fourth wheel speed signal WSS4 from the fourth wheel speed sensor 64 may output a brake control signal for controlling an operation of the fourth brake module 140 to the fourth brake module 140, instead of the first controller 150.

When a failure of the first controller 150 is identified based on whether or not a periodic state signal has been received, the second controller 160 may perform braking control for the first to fourth brake modules 110, 120, 130, and 140 based on first and second wheel speed signals WSS1 and WSS2 output from the first and second wheel speed sensor 61 and 62. Furthermore, the second controller 160 may perform braking control for the first to fourth brake modules 110, 120, 130, and 140 by additionally using third and fourth wheel speed signals WSS3 and WSS4 received from the third controller 170 and the fourth controller 180.

When failures of the first controller 150 and the second controller 160 are identified based on whether or not a periodic state signal has been received, at least one of the third controller 170 and the first controller 150 may perform braking control for the first to fourth brake modules 110, 120, 130, and 140 based on a received wheel speed signal between a third wheel speed signal WSS3 and a fourth wheel speed signal WSS4.

The first power supply 191 and the second power supply 192 may supply power to a preset path and/or a preset device in order to prepare for damage and/or errors of the electrical system and stably perform a set function.

The first power supply 191 may supply first power BAT1 to the first controller 150, and the second power supply 192 may supply second power BAT2 to the second controller 160. Also, the first power supply 191 may supply the first power BAT1 to a preset brake module among the first to fourth brake modules 110, 120, 130, and 140, and the second power supply 192 may supply the second power BAT2 to the remaining brake modules among the first to fourth brake modules 110, 120, 130, and 140.

For example, the first power supply 191 may supply the first power BAT1 to the first brake module 110 and the fourth brake module 140, and the second power supply 192 may supply the second power BAT2 to the second brake module 120 and the third brake module 130.

The brake system according to an embodiment of the disclosure may improve braking stability by being robust against damage and/or errors of vehicle components.

The brake system according to an embodiment of the disclosure may implement redundancy against a braking error by receiving wheel speed signals through multiple channels from the wheel speed sensors installed on the respective wheels.

Also, the brake system according to an embodiment of the disclosure may enhance a degree of freedom of design of a vehicle equipped with an electromechanical brake by installing a wire harness that ensures redundancy in the vehicle.

The brake system according to an embodiment of the disclosure may implement situational redundancy for an electrical device including a wheel speed sensor, a power supply, and/or a controller.

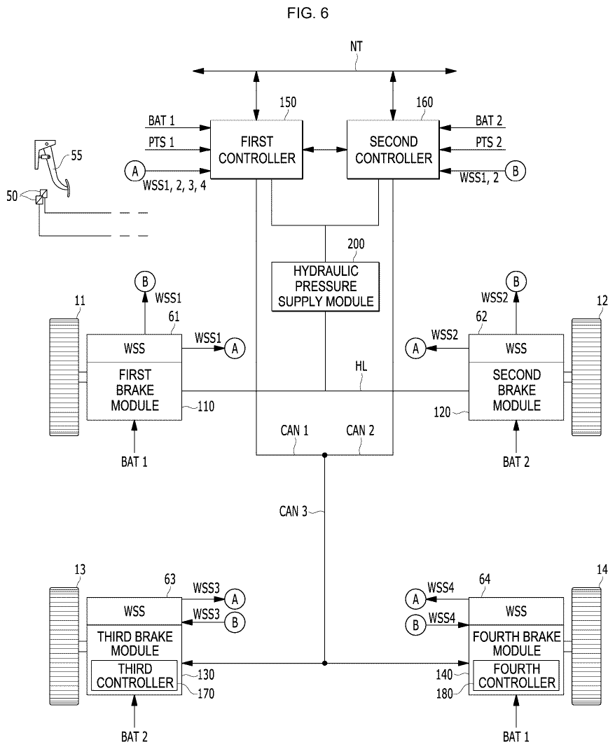

FIG. 6 shows a connection relationship between components included in a brake system according to another embodiment of the disclosure.

The following descriptions will be given by focusing on a connection relationship between communication networks in order to avoid redundant descriptions.

Referring to FIG. 6, the first controller 150 may be connected through the second communication network CAN 1 to a fourth communication network CAN 3 that connects the third brake module 130 and the fourth brake module 140, and the second controller 160 may be connected through the third communication network CAN 2 to the fourth communication network CAN 3 that connects the third brake module 130 and the fourth brake module 140. For example, the second communication network CAN 1 and the third communication network CAN 2 may be connected to the fourth communication network CAN 3 in a Y connection.

The first controller 150 and the second controller 160 may be selectively connected to the fourth communication network CAN 3. For example, the first controller 150 and the second controller 160 may communicate with each other to transmit/receive a periodic state signal to/from each other.

The first controller 150 may identify an operation state (for example, a normal state or a failure state) of the second controller 160 based on whether or not a periodic state signal has been received from the second controller 160. When the first controller 150 identifies a failure of the second controller 160, the first controller 150 may be connected to the fourth communication network CAN 3 through the second communication network CAN 1 and output a brake control signal for controlling operations of the third brake module 130 and the fourth brake module 140 to the third brake module 130 and the fourth brake module 140.

The second controller 160 may identify an operation state (for example, a normal state or a failure state) of the first controller 150 based on whether or not a periodic state signal has been received from the first controller 150. When the second controller 160 identifies a failure of the first controller 150, the second controller 160 may be connected to the fourth communication network CAN 3 through the third communication network CAN 2 and output a brake control signal for controlling operations of the third brake module 130 and the fourth brake module 140 to the third brake module 130 and the fourth brake module 140.

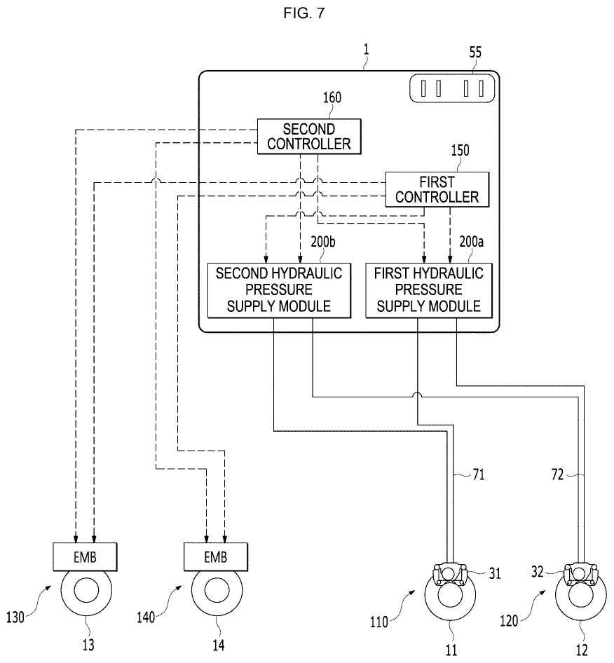

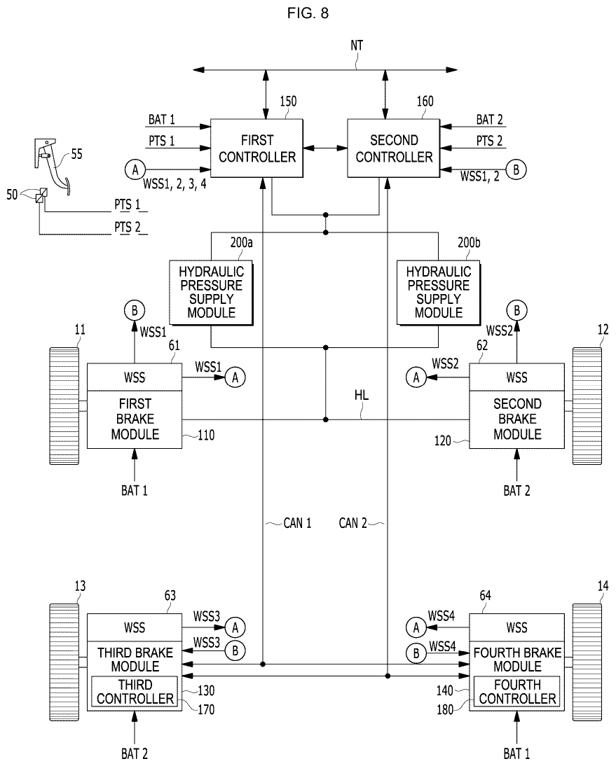

FIG. 7 shows a configuration of a brake system according to another embodiment of the disclosure. FIG. 8 shows a connection relationship between components included in a brake system according to another embodiment of the disclosure.

The following descriptions will be given by focusing on a first hydraulic pressure supply module 200a and a second hydraulic pressure supply module 200b in order to avoid redundant descriptions.

Referring to FIGS. 7 and 8, the first controller 150 may be connected to the first hydraulic pressure supply module 200a and the second hydraulic pressure supply module 200b to perform control of supplying hydraulic pressure to each of the front wheels 11 and 12. Also, the second controller 160 may be connected to the first hydraulic pressure supply module 200a and the second hydraulic pressure supply module 200b to perform control of supplying hydraulic pressure to the front wheels 11 and 12.

In this case, the brake system 100 may stably perform braking control on the front wheels 11 and 12 even when any one of the first hydraulic pressure supply module 200a and the second hydraulic pressure supply module 200b fails and any one of the first controller 150 and the second controller 160 fails.

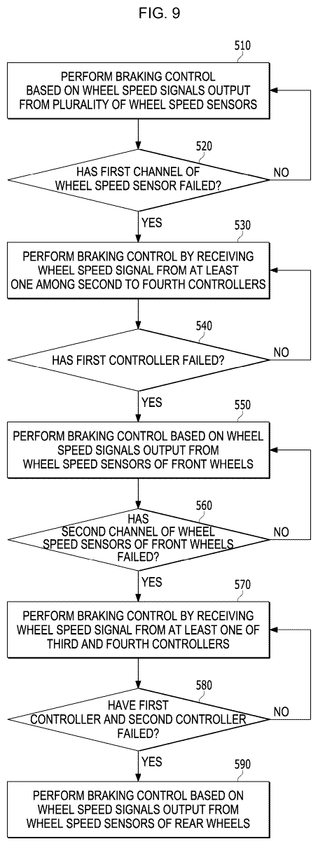

FIG. 9 shows a control method of a brake system according to an embodiment of the disclosure.

Hereinafter, a control method of the above-described brake system will be described.

Referring to FIG. 9, the brake system 100 according to an embodiment of the disclosure may include the first controller 150 and the second controller 160 that perform braking control for the first and second brake modules 110 and 120 of the hydraulic brakes installed on the front wheels 11 and 12 of the vehicle and the third and fourth brake modules 130 and 140 of the electromechanical brakes installed on the rear wheels 13 and 14 of the vehicle, based on wheel speed signals output from the plurality of wheel speed sensors 61, 62, 63, and 64 installed on the respective wheels 11, 12, 13, and 14.

According to the control method of the brake system 100, the first controller 150 may perform braking control for the first to fourth brake modules 110, 120, 130, and 140 based on first to fourth wheel speed signals WSS1, WSS2, WSS3, and WSS4 output from the first to fourth wheel speed sensors 61, 62, 63, and 64 respectively installed on the first to fourth wheels 11, 12, 13, and 14 (510).

When the first controller 150 identifies a failure of the first channel A by failing to receive at least one of the first to fourth wheel speed signals WSS1, WSS2, WSS3, and WSS4 from the first to fourth wheel speed sensors 61, 62, 63, and 64 (520), the first controller 150 may receive a wheel speed signal from at least one among the second controller 160, the third controller 170, and the fourth controller 180, based on the identification of the failure of the first channel A, and perform braking control for the first to fourth brake modules 110, 120, 130, and 140 (530).

When the second controller 160 identifies a failure of the first controller 150 by failing to communicate with the first controller 150 (540), the second controller 160 may perform braking control for the first to fourth brake modules 110, 120, 130, and 140 based on wheel speed signals WSS1 and WSS2 output from the first and second wheel speed sensors 61 and 62 respectively installed on the front wheels 11 and 12 (550).

The first controller 150 and the second controller 160 may transmit/receive a periodic state signal to/from each other, and each of the first controller 150 and the second controller 160 may identify an operation state (a normal state or a failure state) of another party based on whether or not the periodic state signal has been received and perform braking control for the first to fourth brake modules 110, 120, 130, and 140 based on the identified result.

When the second controller 160 identifies a failure of the second channel B by failing to receive wheel speed signals WSS1 and WSS2 from the first and second wheel speed sensors 61 and 62 of the front wheels 11 and 12 (560), the second controller 160 may receive a wheel speed signal from at least one of the third controller 170 and the fourth controller 180 and perform braking control for the first to fourth brake modules 110, 120, 130, and 140 (570).

When at least one of the third controller 170 and the fourth controller 180 identifies failures of the first controller 150 and the second controller 160 by failing to communicate with the first controller 150 and the second controller 160 (580), the at least one of the third controller 170 and the fourth controller 180 may perform braking control for the third and fourth brake modules 130 and 140 based on wheel speed signals WSS3 and WSS4 from the third and fourth wheel speed sensors 63 and 64 respectively installed on the rear wheels 13 and 14 (590).

Each of the third controller 170 and the fourth controller 180 may transmit/receive a periodic state signal to/from the first controller 150 and the second controller 160, identify an operation state (a normal state or a failure state) of other parties based on whether or not the periodic state signal has been received, and perform braking control for the third to fourth brake modules 130 and 140 based on the identified result.

According to an aspect of the disclosure, the brake system and the control method thereof, capable of implementing situational redundancy by receiving wheel speed signals through multiple channels from the wheel speed sensors installed on the respective wheels may be provided.

Also, according to an aspect of the disclosure, the brake system and the control method thereof, capable of improving braking stability by being robust against damage and/or errors of vehicle components may be provided.

Therefore, the brake system and the control method thereof may stably perform braking control for the hydraulic brakes of the front wheels and the electromechanical brakes of the rear wheels, thereby providing high braking stability.

The disclosed embodiments may be implemented in the form of a recording medium that stores instructions executable by a computer. For example, the instructions may be stored in the form of program codes, and when executed by a processor, the instructions may generate a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. However, these embodiments are only examples, not intended to limit the disclosure. It will be understood by one of ordinary skill in the art to which the disclosure belongs that various modifications and applications are possible within the scope that does not depart from the gist of the embodiments. Components described in detail in the embodiments may be modified and embodied. Also, it should be interpreted that differences related to such modifications and applications are included in the scope of the disclosure defined in the attached claims.

What is claimed is:

1. A brake system comprising:
a plurality of wheel speed sensors respectively provided on wheels of a vehicle;
a hydraulic brake provided on a first wheel of the vehicle;
an electromechanical brake provided on a second wheel of the vehicle;
a first controller configured to perform braking control for the hydraulic brake and the electromechanical brake based on a pedal displacement signal corresponding to a movement of a brake pedal or at least one among wheel speed signals output from the plurality of wheel speed sensors; and
a second controller configured to, when a failure of the first controller is identified, perform braking control for the hydraulic brake and the electromechanical brake based on the pedal displacement signal or at least one among wheel speed signals output from the plurality of wheel speed sensors,
wherein the electromechanical brake comprises a third controller configured to, when failures of the first controller and the second controller are identified, perform braking control for the electromechanical brake based on the pedal displacement signal or at least one among wheel speed signals output from the plurality of wheel speed sensors.

2. The brake system of claim 1, where the plurality of wheel speed sensors are configured to respectively output the wheel speed signals through a first channel and a second channel and output the wheel speed signals to the first controller through the first channel.

3. The brake system of claim 2, wherein
the wheel speed sensor provided on the first wheel is configured to output the wheel speed signal to the second controller through the second channel, and
the wheel speed sensor provided on the second wheel is configured to output the wheel speed signal to the third controller through the second channel.

4. The brake system of claim 2, wherein
the first controller is configured to perform braking control for the hydraulic brake and the electromechanical brake by receiving the wheel speed signal from at least one of the second controller and the third controller based on identification of a failure of the first channel.

5. The brake system of claim 3, wherein
the second controller is configured to perform braking control for the hydraulic brake and the electromechanical brake by receiving a wheel speed signal from the third controller based on identification of a failure of the second channel.

6. The brake system of claim 1, wherein
the first controller is configured to, when a failure of the wheel speed sensor provided on the second wheel is identified, perform braking control for the hydraulic brake and the electromechanical brake based on a wheel speed signal output from the wheel speed sensor provided on the first wheel.

7. The brake system of claim 1, further comprising
a first communication network connecting the first controller and the second controller,
wherein each of the first controller and the second controller identifies a state of another party through the first communication network.

8. The brake system of claim 1, further comprising
a second communication network connecting the first controller and the third controller,
wherein each of the first controller and the third controller identifies a state of another party through the second communication network.

9. The brake system of claim 1, further comprising
a third communication network connecting the second controller and the third controller
wherein each of the second controller and the third controller identifies a state of another party through the third communication network.

10. The brake system of claim 7, further comprising
a second communication network connecting the first controller and the third controller, a third communication network connecting the second controller and the third controller, and a fourth communication network connecting the electromechanical brake provided on the second wheel,
wherein the second communication network and the third communication network are connected in parallel to the fourth communication network.

11. The brake system of claim 10, wherein
the first controller or the second controller is selectively connected to the fourth communication network through the second communication network or the third communication network based on an identified state of another party.

12. The brake system of claim 1, further comprising
a hydraulic pressure supply module configured to supply hydraulic pressure to the hydraulic brake,
wherein at least one of the first controller and the second controller is configured to control the hydraulic pressure supply module to supply hydraulic pressure to the hydraulic brake.

13. The brake system of claim 1, further comprising
a first hydraulic pressure supply module and a second hydraulic pressure supply module configured to supply hydraulic pressure to the hydraulic brake,
wherein at least one of the first controller and the second controller is configured to control the first hydraulic pressure supply module and the second hydraulic pressure supply module to supply hydraulic pressure to the hydraulic brake.

14. A method of controlling a brake system, the brake system comprising a plurality of wheel speed sensors respectively provided on wheels of a vehicle, a hydraulic brake provided on a first wheel of the vehicle, and an electromechanical brake provided on a second wheel of the vehicle, the method comprising
at a first controller, performing braking control for the hydraulic brake and the electromechanical brake based on a pedal displacement signal corresponding to a movement of a brake pedal or at least one among wheel speed signals output from the plurality of wheel speed sensors,
at a second controller, when a failure of the first controller is identified, performing braking control for the hydraulic brake and the electromechanical brake based on at least one of the pedal displacement signal or at least one of wheel speed signals output from the plurality of wheel speed sensors, and
at a third controller of the electromechanical brake, when failures of the first controller and the second controller are identified, performing braking control for the electromechanical brake based on the pedal displacement signal or at least one among wheel speed signals output from the plurality of wheel speed sensors.

15. The method of claim 14, further comprising
at the plurality of wheel speed sensors, respectively outputting the wheel speed signals through a first channel and a second channel and outputting the wheel speed signals to the first controller through the first channel,
at the wheel speed sensor provided on the first wheel, outputting the wheel speed signal to the second controller through the second channel, and
at the wheel speed sensor provided on the second wheel, outputting the wheel speed signal to the third controller through the second channel.

16. The method of claim 15, further comprising
at the first controller, performing braking control for the hydraulic brake and the electromechanical brake by receiving the wheel speed signal from at least one of the second controller and the third controller based on identification of a failure of the first channel.

17. The method of claim 15, further comprising
at the second controller, performing braking control for the hydraulic brake and the electromechanical brake by receiving the wheel speed signal from the third controller based on identification of a failure of the second channel.

18. The method of claim 14, further comprising
at the first controller, when a failure of the wheel speed sensor provided on the second wheel is identified, performing braking control for the hydraulic brake and the electromechanical brake based on a wheel speed signal output from the wheel speed sensor provided on the first wheel.

19. The method of claim 14, the brake system further comprising a first communication network connecting the first controller and the second controller, a second communication network connecting the first controller and the third controller, a third communication network connecting the second controller and the third controller, and a fourth communication network connecting the electromechanical brake provided on the second wheel,
the method further comprising
at each of the first controller and the second controller, identifying a state of another party through the first communication network, at each of the first controller and the third controller, identifying a state of another party through the second communication network, and at each of the second controller and the third controller, identifying a state of another party through the third communication network.

20. The method of claim 19, wherein
the second communication network and the third communication network are connected in parallel to the fourth communication network,
the method further comprising
at the first controller or the second controller, selectively connecting to the fourth communication network through the second communication network or the third communication network based on an identified state of another party.
